(19) United States
(12) Patent Application Publication
(10) Pub. No.: US 2026/0158831 A1
(43) Pub. Date: Jun. 11, 2026

(54) CUSTOMIZABLE INNER TIRE INSERT

(71) Applicant: Yaniv Matza, Tamarac, FL (US)

(72) Inventor: Yaniv Matza, Tamarac, FL (US)

(21) Appl. No.: 18/971,432

(22) Filed: Dec. 6, 2024

(51) Int. Cl. B60C 19/12

(52) U.S. Cl. CPC B60C 19/12

(57) ABSTRACT

A customizable inner tire insert may include an inflatable duct; a puncture-resistant, pressure-adjustable insert at least partially surrounding the inflatable duct; and a valve in operable communication with the inflatable duct.

### TECHNICAL FIELD

The embodiments generally relate to the technical field of tire inserts.

### BACKGROUND

Conventional tire systems may include internal tubes, inserts, etc. that may be inflatable to provide structural support to the tire. Motorcycle inner tubes are inflatable tire inserts usually made of rubber, designed to retain air and offer cushioning and support for the tire. However, they have several disadvantages and limitations, such as being prone to pinches or flats, experiencing air loss immediately or over time, and needing complete replacement in case of punctures. Some tire inserts may substitute a traditional inflatable inner tube with a solid insert, effectively mimicking a tube's inner shape with a solid structure made from dense foam. The purpose of this type of insert is to eliminate the possibility of a flat tire. The disadvantage of this structurally solid insert is weight, as the dense material adds significantly extra weight to a rider's vehicle. A limitation is that the air pressure is set to the density of the foam and cannot be adjusted for different riding conditions.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, the customizable inner tire insert may include an inflatable duct; a puncture-resistant, pressure-adjustable insert at least partially surrounding the inflatable duct; and a valve in operable communication with the inflatable duct.

In one aspect, the customizable inner tire insert may include a solid, flexible insert concentrically enveloping the inflatable duct, such that when the inflatable duct is inflated, the solid, flexible insert applies pressure to a surrounding bike tire.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a customizable inner tire insert, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A customizable inner tire insert insert may feature a customizable, puncture-resistant tire insert with an adjustable pressure system via an inflatable duct. The customizable inner tire insert may overcome the limitations of existing tire protection systems by introducing a dual-functionality tire insert that combines puncture resistance with pressure adjustment capabilities for off-road vehicles. This insert significantly reduces the risk of flat tires and pinch flats in off-road vehicles when installed inside any standard tire. The insert is placed inside a tire before it is mounted onto the rim. Once installed, the operator can modify the air pressure through the valve stem, adjusting the tire's “footprint” as needed. Additionally, it allows for air pressure adjustments to accommodate different riding conditions. The customizable inner tire insert includes a puncture-resistant material for the insert, which allows for air pressure adjustment, simulating changes in the insert's density.

A customizable inner tire insert may include an inflatable duct configured to be inflated to apply pressure on the insert surrounding the inflatable duct. The inflatable duct and insert may be inserted within, for example, a bike tire, wherein the customizable inner tire insert is configured to apply variable pressure to a bike tire.

A customizable inner tire insert may include a puncture-resistant, pressure-adjustable insert at least partially surrounding the inflatable duct, wherein the insert comprises a flexible, solid structure. In some embodiments, the insert at least partially concentrically surrounds the inflatable duct. In some embodiments, the insert may include at least one longitudinal channel defined by an outer surface of the insert.

A customizable inner tire insert may include a valve in operable communication with the inflatable duct, wherein the valve is configured to facilitate inflating the inflatable duct.

In use, the tire insert is first placed inside a tire without a rim, and then the tire with the insert is mounted onto the rim. The operator can adjust the air pressure using the air valve stem. By modifying the air pressure in the inflatable duct, the “footprint” of the tire can be increased or decreased as needed. In this way, the customizable inner tire insert provides a lightweight, puncture-resistant tire insert with an adjustable internal air duct system that allows riders to customize tire pressure on the go for different terrains while maintaining puncture protection, improving the limitations of fixed-density foam inserts and vulnerable traditional inner tubes.

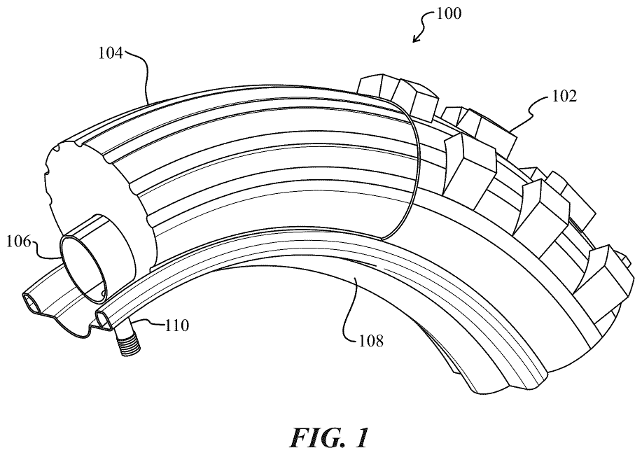

FIG. 1 depicts a variation of the disclosed customizable inner tire insert 100 disposed within a bike tire 102 and fixed onto a bike rim 108. The customizable inner tire insert 100 may include an inflatable duct 106 and a puncture-resistant, pressure-adjustable insert 104 at least partially surrounding the inflatable duct 106. The customizable inner tire insert 100 may include a valve 110 in operable communication with the inflatable duct 106 such that the inflatable duct 106 may be inflated to user preference. That is, the inflatable duct 106 may be inflated to a desired pressure such that the insert 104 exerts radial pressure on the tire 102, while also providing a flat-resistant tire system.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A customizable inner tire insert comprising:
an inflatable duct;
a puncture-resistant, pressure-adjustable insert at least partially surrounding the inflatable duct; and
a valve in operable communication with the inflatable duct.

2. The customizable inner tire insert of claim 1, wherein the insert comprises a solid, flexible structure.

3. The customizable inner tire insert of claim 2, wherein the solid, flexible structure is compressible.

4. The customizable inner tire insert of claim 1, wherein the insert comprises at least one longitudinal channel defined by an outer surface of the insert.

5. The customizable inner tire insert of claim 4, wherein the at least one longitudinal channel comprises a plurality of longitudinal channel defined by the outer surface of the insert.

6. The customizable inner tire insert of claim 1, wherein the insert at least partially concentrically surrounds the inflatable duct.

7. The customizable inner tire insert of claim 1, wherein the inflatable duct is configured to be inflated to apply pressure on the insert.

8. The customizable inner tire insert of claim 1, wherein the valve is configured to facilitate inflating the inflatable duct.

9. The customizable inner tire insert of claim 1, wherein the customizable inner tire insert is configured to apply variable pressure to a bike tire.

10. A customizable inner tire insert comprising:
a tire defining a channel;
a puncture-resistant, pressure-adjustable insert at least partially surrounding an inflatable duct, wherein the insert and the inflatable duct are positioned in the channel; and
a valve in operable communication with the inflatable duct.

11. The customizable inner tire insert of claim 10, wherein the insert comprises a solid, flexible structure.

12. The customizable inner tire insert of claim 11, wherein the solid, flexible structure is compressible.

13. The customizable inner tire insert of claim 10, wherein the insert comprises at least one longitudinal channel defined by an outer surface of the insert.

14. The customizable inner tire insert of claim 13, wherein the at least one longitudinal channel comprises a plurality of longitudinal channel defined by the outer surface of the insert.

15. The customizable inner tire insert of claim 10, wherein the insert at least partially concentrically surrounds the inflatable duct.

16. The customizable inner tire insert of claim 10, wherein the inflatable duct is configured to be inflated to apply pressure on the insert.

17. The customizable inner tire insert of claim 10, wherein the valve is configured to facilitate inflating the inflatable duct.

18. The customizable inner tire insert of claim 10, wherein the customizable inner tire insert is configured to apply variable pressure to a bike tire.

19. The customizable inner tire insert of claim 10, further comprising a standard rim, and wherein the tire, the insert, and the inflatable duct are mounted on the rim.

20. A customizable inner tire insert comprising:
a tire defining a channel;
and inflatable duct;
a puncture-resistant, pressure-adjustable insert at least partially concentrically surrounding the inflatable duct, wherein the insert and the inflatable duct are positioned in the channel and wherein the inflatable duct is configured to be inflated to apply pressure on the insert, and wherein the insert defines a plurality of longitudinal channel on an outer surface of the insert; and
a valve in operable communication with the inflatable duct, wherein the valve is configured to facilitate inflating the inflatable duct once the tire and the customizable inner tire insert are mounted on a rim.
